(19) United States
(12) Patent Application Publication
(10) Pub. No.: US 2011/0064345 A1
(43) Pub. Date: Mar. 17, 2011

(54) ROLLING ELEMENT HAVING LUBRICANT DEPOT AND ROLLER BEARING

(75) Inventors: Hans-Juergen Fandre, Oerlenbach (DE); Alexander Tietz, Schweinfurt (DE)

(73) Assignee: SCHAEFFLER TECHNOLOGIES GMBH & CO. KG, Herzogenaurach (DE)

(21) Appl. No.: 12/864,321

(22) PCT Filed: Jan. 23, 2009
(86) PCT No.: PCT/DE2009/000087

§ 371 Date: Sep. 15, 2010

(30) Foreign Application Priority Data
Jan. 26, 2008 (DE) 10 2008 006 150.6

(51) Int. Cl. F16C 19/00; F16C 19/22

(52) U.S. Cl. 384/473; 384/548

(57) ABSTRACT

A rolling element for a roller bearing and a corresponding roller bearing for lubrication. To this end, a rolling element for a roller bearing which has a base body with a receptacle and a lubricant depot is proposed. The lubricant depot is disposed in the receptacle, and has a mounting device disposed in the receptacle and forms a boundary surface on the edge for the lubricant depot.

### FIELD OF THE INVENTION

The invention relates to a rolling body for a roller bearing with a base body, wherein the base body includes a retainer, and with a lubricant reservoir, wherein the lubricant reservoir is arranged in the retainer, and with a roller bearing with at least one such rolling body.

Roller bearings, such as, for example, ball bearings or roller bearings, usually have a plurality of rolling bodies, wherein the rolling bodies roll during operation between two rolling body races. In axial roller bearings or radial roller bearings, the roller races may be arranged, for example, on disks or rings, while in linear roller bearings the races are arranged on a moving body.

The rolling bodies are usually supplied with lubricant in the roller bearing. In this connection, it is known, for example, to use an external lubricant feed which, during operation, supplies lubricant to the roller bearing continuously or in intervals. In a possible alternative solution, pre-lubricated or permanently lubricated roller bearings are used, wherein the bearings are, already during manufacture, with a lubricant reservoir for their entire service life.

Publication JP2004-176771 A (publication number) discloses a taper roller bearing with a plurality of tapered rollers as rolling bodies, wherein at least one tapered roller has an integrated lubricant reservoir. In particular, a manufacturing method for tapered rollers lubricated with solid lubricant, wherein the tapered roller has a stepped and truncated cone-shaped through-hole into which a form piece from a solid lubricant is inserted.

The invention is based on the object of proposing a rolling body for a rolling body bearing or a corresponding rolling body bearing, wherein the bearing has an improved lubrication.

This object is met by a rolling body with the features of claim 1 or 11, and a roller bearing with the features of claim 13. Preferred or advantageous embodiments of the invention result from the dependent claims, the subsequent description and/or the enclosed Figures.

The rolling body according to the invention is suitable and/or constructed for a roller bearing and has a base body on the outer sides of which contact or rolling surfaces are arranged, which roll during operation on corresponding races. The rolling body may have, in the most general embodiment of the invention, a freely selected shape, in particular, the rolling body may be constructed as a spherical roller, tapered roller or cylindrical roller, etc. The roller bearing may be constructed as an axial bearing, radial bearing or as a linear bearing. In principle, the rolling body according to the invention can be used in any structural configuration of roller bearings. The material of the base body is preferably metal, particularly steel; alternatively, synthetic material, ceramic or non-ferrous metal can be used.

The base body includes a retainer, i.e., especially a recess which is dimensioned in such a way that a lubricant reservoir can be arranged in the retainer.

The lubricant reservoir includes a solid or liquid lubricant, particularly an oil or grease, or any other lubricant. The lubricant reservoir is secured or integrated in the rolling body and is moved during operation together with the latter.

In accordance with the invention it is proposed to use a holding device for the lubricant reservoir, which is arranged in the retainer and which forms, at least in sections, a limiting surface for the lubricant reservoir at the edge, and particularly delimits for the lubricant reservoir laterally.

A consideration of the invention is to be seen in the fact that securing the lubricant reservoir, as it is known from the prior art, is susceptible to injuries to the lubricant reservoir during or after the assembly, because the form piece is very delicate. In the worst case, an injury of the form piece may lead to an insufficient filling of the rolling body with lubricant.

In contrast, it is proposed in the invention to use a supplemental holding device, which forms a limiting surface for the lubricant reservoir on the edge and which fixes the reservoir in the retainer. In particular, the limiting surface serves for the positively engaging retainer or placement of the lubricant reservoir. With the use of the further development according to the invention, the lubricant reservoir is protected against injuries at least in the area of the limiting surface.

In a preferred embodiment of the invention, the retainer is realized as a through-hole, particularly through a rotation center or along an axis of rotation of the rolling body. In this embodiment, the lubricant of the lubricant reservoir can be introduced into the roller bearing on two outlet sides of the retainer.

In accordance with another alternative of the invention, the retainer is constructed as a blind-end bore which, consequently, has only one outlet side for the lubricant.

In a variation, which can be manufactured advantageously with respect to manufacturing technology, the retainer has a depth extension through the rolling body with a constant cross-section. Particularly preferred is the construction of the retainer as a bore. The free diameter of the bore is, for example, less than half the diameter of the rolling body, in order to ensure a sufficient stability of the rolling body.

In alternative embodiments of the invention, the retainer has, over the depth extension thereof, a variable cross-section. In particular, the retainer may be adapted to the shape of the rolling body (for example, conical for tapered rollers). A possible embodiment resides in that the cross-section extends at least in sections parallel to the rolling surface of the rolling body or at least approximately parallel thereto. For example, a tapered roller may have a conical retainer. In another embodiment, the retainer has on one or both outlet sides thereof a funnel-shaped widening in order to better dispense the lubricant from the retainer. Combinations of these embodiments are also possible.

It is preferred that the limiting surface implements a holding and/or metering function for the lubricant.

In a structural realization of the invention, the holding device forms on one or both outlet sides of the retainer a limiting surface or surfaces for the lubrication depot which preferably extends perpendicularly to the depth extension of the retainer and which limiting surface or surfaces cover the outlet sides.

In a particularly preferred embodiment, the limiting surface is constructed as a portion of a cover section, wherein the cover section preferably has one or more holes through which the lubricant can emerge, so that the limiting surface implements the metering function. Optionally, the cover section can merge into a sleeve section which is supported radially outwardly at the retainer, wherein the cover section then increasingly realizes the holding function more.

In a possible realization of the invention, the holding device is constructed as a capsule. During the assembly of the rolling body or the roller bearing, this capsule can be, for example, inserted, pushed in and/or pressed into the retainer as a lubricant-filled unit.

In this connection, it is within the scope of the invention that the capsule is constructed as a single piece and the lubricant reservoir is completely surrounded by the capsule except for discharge holes. This capsule can be placed particularly simply into the rolling body or—for example, in the case of maintenance operations—can be replaced.

Alternatively, the capsule is constructed of multiple parts, preferably two parts. In this connection, the capsule can be constructed so as to be capable of being plugged together, so that the capsule is in a first step filled with the lubricant and in a second step is plugged together and is then inserted into the rolling body. It is also conceivable that the capsule has one or more partition planes, preferably a partition plane which centrally divides the capsule in the depth dimension in the retainer, so that in the area of the dividing planes there are gaps, particularly annular gaps for a controlled discharge of the lubricant.

In a less preferred embodiment, the holding device is constructed as a sleeve or other body, wherein the sleeve or other body is open at the outlet side or outlet sides of the retainer. This embodiment essentially only implements the holding function.

In a further development of the invention, or in another subject of the invention, the lubricant reservoir is constructed as a sponge which is saturated with lubricant. It is particularly preferred if the sponge is elastic or compressible, so that the sponge elastically rests against the retainer and, as a result, secures the lubricant reservoir in a frictionally or positively engaging manner in the retainer and/or in the holding device.

Another subject of the invention relates to a roller bearing with one or more rolling bodies according to one of the preceding claims.

The roller bearing may be constructed as a sealed roller bearing, wherein the rolling bodies space is closed off by seals, particularly sealing rings, in order to implement in this manner, for example, a service life lubrication of the roller bearing. In this embodiment, it is made possible that in spite of the limited free space in the sealed roller bearing space, a sufficient lubricant amount can be deposited.

In an alternative embodiment, the roller bearing is constructed as an open bearing which is to be additionally equipped with a lubricant reservoir.

Additional features, advantages and effects of the invention result from the following description of preferred embodiments of the invention as well as the enclosed Figures. In the drawing:

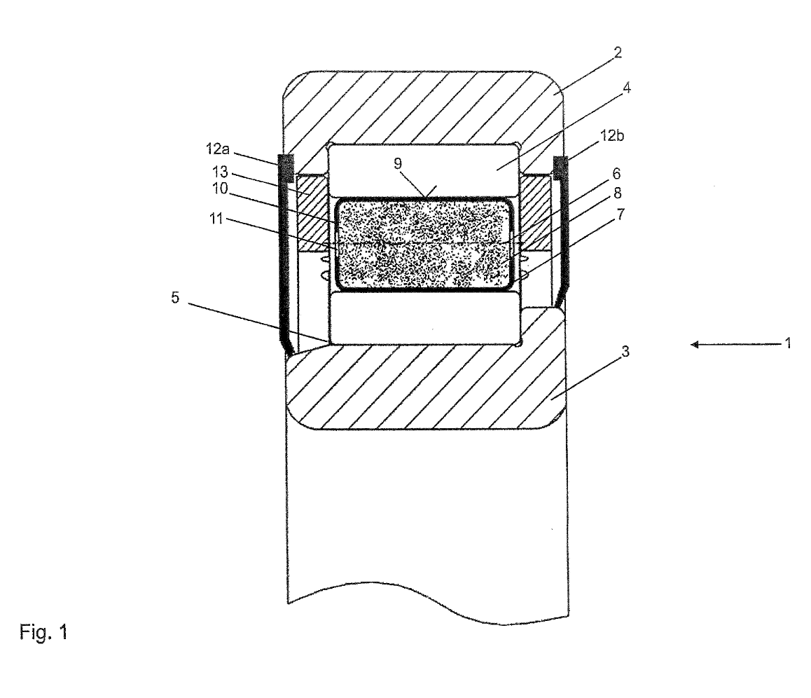

FIG. 1 is a schematic longitudinal sectional view through a roller of a roller bearing as a first embodiment of the invention;

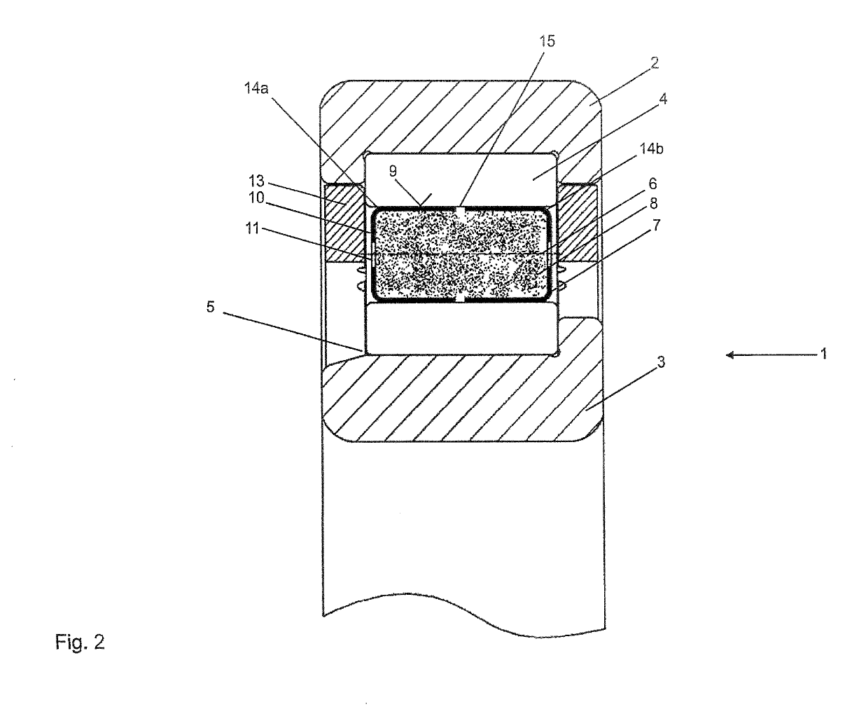

FIG. 2 is a schematic longitudinal sectional view through a roller of a roller bearing as a second embodiment of the invention;

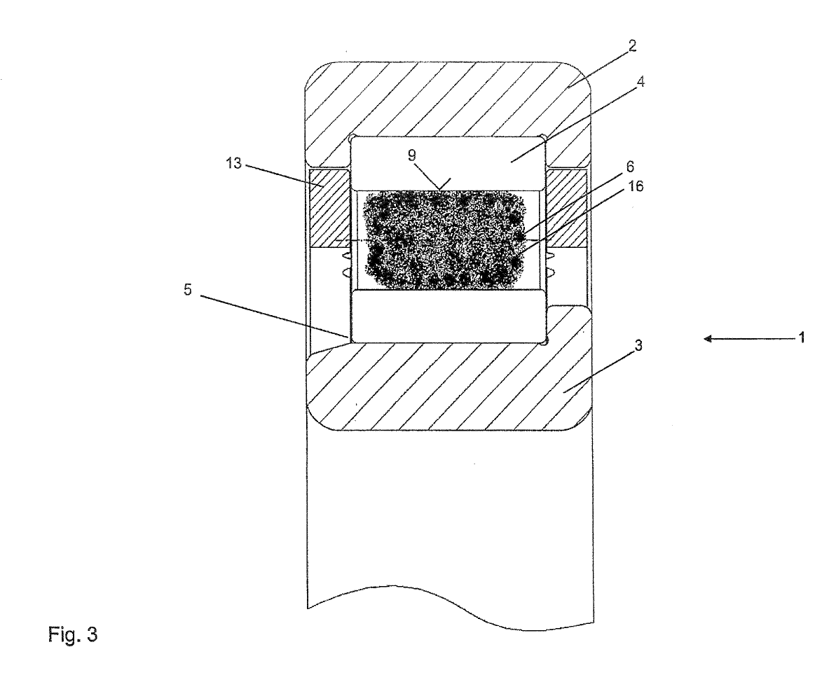

FIG. 3 is a schematic longitudinal sectional view through a roller of a roller bearing as a third embodiment of the invention.

In the drawings, components which are equivalent or equal are in the drawing provided with the same or corresponding reference characters.

FIG. 1 shows in a schematic longitudinal sectional view of a detail of a roller bearing 1 an outer ring 2, an inner ring 3 as well as a roller 4, which rolls between the outer ring 2 and the inner ring 3. The outer ring 2 has two lateral boards which laterally guide the roller 4. In contrast, the inner ring 3 only has on the right side thereof a board for guiding the roller 4. The roller 4 forms the rolling body, which rolls on the races of the outer ring 2 and the inner ring 3 and has a cylindrical shape.

The roller 4 has a through-hole 5 which is constructed as a bore with constant cross-section and which extends symmetrically relative to the axis of rotation 6 of the roller 4.

The diameter of the through-hole 5 is dimensioned in such a way that it is arranged in the axial projection without overlapping with the boards of the rings 2 and 3.

In the through-hole 5, a capsule 7 is received and secured in a positively and/or frictionally engaging manner. The capsule 7 has an outer wall which, in the illustrated sectional longitudinal view, is constructed rectangular, wherein the side surface 9 is arranged or aligned parallel to the rolling surface of the roller 4 and the cover surfaces 10 are arranged or aligned perpendicular to the axis of rotation of the roller 4, and arranged somewhat offset in the retainer 5. The capsule 7 serves to receive a lubricant reservoir 8 and is manufactured, for example, of synthetic material.

In the cover sections 10, the capsule 7 has holes 11 which permit the emergence of lubricant from the lubricant reservoir 8 into the roller bearing 1 during operation. The lubricant reservoir 8 is formed by a liquid or solid lubricant, particularly oil or grease, which optionally is absorbed in a carrier substrate, for example, a porous body or a sponge.

During operation, the lubricant emerges from the lubricant reservoir 8 through the holes 11 with a significant time delay, so that a lubricant supply of the roller bearing 1 is ensured over long periods of operation.

The roller bearing 1 shown in FIG. 1 is constructed as a bearing which is lubricated over its entire service life and has in both sides a seal 12a, b which seals the rolling bodies space relative to environmental influences. Optionally, the roller bearing 1 has a cage 13.

During manufacture of the roller 4, the capsule 7 can be pushed into the roller 4 or can be replaced, if necessary, in a simple manner together with the lubricant reservoir 8.

FIG. 2 shows a modification of the first embodiment of FIG. 1, wherein, in contrast to FIG. 1, the capsule 7 is constructed of two parts and has a first cup-shaped or hat-shaped capsule half 14a and a second capsule half 14b. As an example, the roller bearing 1 is shown as an open bearing without seals 12a, b. The capsule halves 14a and b are arranged spaced apart from each other in the axial direction and together form an annular gap 15 which permits lubricant to emerge from the lubricant reservoir 8.

As an alternative or in supplementing the holes 11 in the cover section 10, in the embodiments shown in the Figures, it is also possible to provide holes or cutouts in the side surface 9, for example, the annular gap 15.

FIG. 3 shows in the same view a third embodiment of the invention, wherein a sponge 16 is placed instead of the capsule 7 in the retainer 5 of the roller 4, wherein the sponge 16 is separate from the lubricant. Preferably, sponge 16 is constructed so as to be elastic, so that the sponge is clamped in the retainer 5.

### REFERENCE NUMERALS

1 Roller bearing, rolling bodies bearing
2 Outer ring
3 Inner ring
4 Roller
5 Through-hole, reception
6 Axis of rotation
7 Capsule
8 Lubricant reservoir
9 Side surface
10 Cover surface
11 Holes
12a, b Seal
13 Cage
14a First capsule half
14b Second capsule half
15 Ring gap
16 Sponge

1. A rolling body for a roller bearing, comprising:
a base body which has a retainer; and
a lubricant reservoir,
wherein the lubricant reservoir is arranged in the retainer, and wherein
a holding device, which is arranged in the retainer,
forms a limiting surface at an edge for the lubricant reservoir.

2. The rolling body of claim 1, wherein the retainer is a through-hole.

3. The rolling body of claim 1 wherein the retainer (5) is constructed as a blind-end hole.

4. The rolling body of claim 1, wherein the retainer has a constant cross-section over a depth extension thereof.

5. The rolling body of claim 1, wherein the retainer has over a depth extension thereof a variable cross-section, and wherein the walls of the retainer extend parallel to the rolling surface.

6. The rolling body of claim 1, wherein the holding device forms at one or both outlet sides of the retainer the limiting surfaceor limiting surfaces for the lubricant reservoir.

7. The rolling body of claim 6, wherein the limiting surface is constructed as a cover section with one or more through holes.

8. The rolling body of claim 1, wherein the holding device is constructed as a capsule.

9. The rolling body of claim 8, wherein the capsule is constructed in one piece.

10. The rolling body of claim 8, wherein the capsule is constructed of two or more parts.

11. The rolling body of claim 1, wherein the lubricant reservoir is constructed as a sponge impregnated with lubricant.

12. The rolling body of claim 11, wherein the sponge is constructed to be elastic.

13. The roller bearing with one or more rolling bodies according to claim 1.

14. The roller bearing of claim 13, wherein the rolling bodies space is closed off by seals.
